(19) United States
(12) Patent Application Publication
(10) Pub. No.: US 2005/0134883 A1
(43) Pub. Date: Jun. 23, 2005

(54) Image forming apparatus having a graphic-LCD and a method thereof

(76) Inventor: Jin-tae Chung, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/978,442

(22) Filed: Nov. 2, 2004

(30) Foreign Application Priority Data
Nov. 5, 2003 (KR) 2003-77849

(51) Int. Cl. G06F 17/21; G06T 11/00; G06K 15/00

(52) U.S. Cl. 358/1.11; 347/3; 715/542; 345/471

(57) ABSTRACT

Disclosed is an image forming apparatus having a graphic-LCD, comprising a printer module for storing a binary font for an inkjet printer, and converting the inkjet printer binary font which corresponds to an inputted data to an image data to print out, and a graphic-LCD module for displaying a state of the printer module on a screen, converting the inkjet printer binary font to the graphic-LCD image font, and displaying a text on the screen. Accordingly, the manufacturing cost for the image forming apparatus can be saved.

### CROSS-REFERENCE TO RELATED APPLICATIONS

This application claims the benefit under 35 U.S.C. 119(a) of Korean Patent Application No. 2003-77849, filed Nov. 5, 2003, in the Korean Intellectual Property Office, the entire content of which is incorporated herein by reference.

### BACKGROUND OF THE INVENTION

1. Field of the Invention

The present invention relates to an image forming apparatus having a graphic-liquid crystal display (graphic-LCD) and a method thereof. More particularly, the present invention relates to an inkjet printer or an image forming apparatus having the functions of an inkjet printer, which has a graphic-LCD to convert a font for use in the inkjet printer to a form displayable on the graphic-LCD.

2. Description of the Related Art

Generally, an image forming apparatus records an image corresponding to an image data, on a recording media such as a paper. The image forming apparatus may include an inkjet printer, and an office machine having functions of an inkjet printer.

Image forming apparatuses are mass-produced, have diverse functions, and employ a display.

FIG. 1 is a block diagram showing a conventional image forming apparatus having a graphic-LCD which comprises a control unit 10, a graphic-LCD module 20, and a printer module 30.

The control unit 10 controls the graphic-LCD module 20 according to a user's input command to display text on a graphic-LCD 28, and controls the printer module 30 to perform a print job.

The graphic-LCD module 20 displays text on the graphic-LCD, corresponding to a graphic-LCD text display command which is received from a predetermined inputting means (not shown). The graphic-LCD module 20 comprises an image font storage unit 22, a display control unit 24, an image buffer 26, and the graphic-LCD 28.

The image font storage unit 22 stores image font for the graphic-LCD. A display such as an LCD can display font using ASCII code corresponding to the font. However, the graphic-LCD requires extra memory for storing the image fonts having Red, Green, Blue (RGB) values.

The display control unit 24 controls the stored RGB data of the graphic-LCD image font, adjusts color, and controls the size of the font. The image buffer 26 stores the image font which is controlled in color and size. The graphic-LCD displays the image font stored in the image buffer 24.

The printer module 30 performs printing, and comprises a binary font storage unit 32, an image generator 34, a print buffer 36, and a print engine 38.

The binary font storage unit 32 stores the binary font for the inkjet printer of the binary data system rotated clockwise by 270° according to features of an inkjet printing system, in which an area to be printed is defined as “1”, and an area not to be printed is defined as “0”.

The image generator 34 converts the binary font for the inkjet printer to be printed to image data. The print buffer 26 stores the image data processed at the image generator 34, and the print engine 38 prints the image data stored in the print buffer 36.

As described above, the conventional image forming apparatus having the graphic-LCD has both the graphic-LCD image font, and the binary font for the printer with respect to one font. Therefore, the manufacturing cost increases.

### SUMMARY OF THE INVENTION

The present invention has been made to overcome the above-mentioned problems of the prior art. Accordingly, it is an aspect of the present invention to provide an image forming apparatus having a graphic-liquid crystal display (graphic-LCD) which displays a text on the graphic-LCD using an inkjet printer font in order to save memory and reduce manufacturing costs, and the method of the same.

In order to achieve the above-described aspects of the present invention, there is provided an image forming apparatus having the graphic-LCD, which comprises a printer module for storing a binary font for use in an inkjet printer, and converting the inkjet printer binary font which corresponds to an input data to an image data to print out; and a graphic-LCD module for displaying a state of the printer module on a screen, converting the inkjet printer binary font to the graphic-LCD image font, and displaying text on the screen.

In an embodiment of the present invention, the printer module comprises a binary font storage for storing the inkjet printer binary font, an image generator for converting the inkjet printer binary font to the image data, and a print engine for printing out the image data on a paper.

The graphic-LCD module comprises a font format conversion unit for converting the inkjet printer binary font to the graphic-LCD image font, a display control unit for controlling color and size of the converted graphic-LCD image font, and a graphic-LCD for displaying the controlled graphic-LCD image font.

The font format conversion unit comprises a rotation conversion unit for rotating the inkjet printer binary font being displayed to a correct position, and an image conversion unit for converting the inkjet printer binary font to the graphic-LCD image font having a RGB value.

The image forming apparatus is an office machine combined with at least one of a facsimile, a copier, a printer, and a scanner, and the graphic-LCD module displays a state of the office machine.

According to an embodiment of the present invention, a method for a graphic-LCD of an image forming apparatus which prints out text using a binary font for an inkjet printer, comprises the steps of reading the binary font for the inkjet printer, and graphic-LCD processing in which the read inkjet printer binary font is converted to a graphic-LCD image font, and the text based on the converted graphic-LCD image font is displayed.

The graphic-LCD processing comprises the steps of font format converting which converts the read inkjet printer binary font to the graphic-LCD image font, controlling the display in order to control the color and size of the converted graphic-LCD image font, and displaying the controlled graphic-LCD image font on a screen.

The font format converting comprises the steps of rotation converting which rotates the inkjet printer binary font being displayed to a correct position, and image converting which converts the inkjet printer binary font to the graphic-LCD image font having a RGB value.

In an embodiment of the present invention, the method further comprises the steps of image generating which converts the inkjet printer binary font to the image data, and printing out the image data on a paper.

The image forming apparatus is an office machine combined with at least one of a facsimile, a copier, a printer, and a scanner, and the graphic-LCD module displays a state of the office machine.

A graphic-LCD which displays text using a font for an inkjet printer, comprises a binary font storage unit for storing the binary font for the inkjet printer, a font format conversion unit for converting the inkjet printer binary font to the graphic-LCD image font, a display control unit for controlling color and size of the converted graphic-LCD image font, and a graphic-LCD for displaying the controlled graphic-LCD image font.

The font format conversion unit comprises a rotation conversion unit for rotating the inkjet printer binary font being displayed to a correct position, and an image conversion unit for converting the inkjet printer binary font to the graphic-LCD image font having a RGB value.

According to an embodiment of the present invention, a method for a graphic-LCD which displays text using a font for an inkjet printer, comprises the steps of storing a binary font for the inkjet printer, font format converting which converts the read inkjet printer binary font to the graphic-LCD image font, display controlling which controls color and size of the converted graphic-LCD image font, and graphic-LCD displaying which displays the controlled graphic-LCD image font on a screen.

The font format converting comprises the steps of rotation converting which rotates the inkjet printer binary font being displayed to a correct position, and image converting which converts the inkjet printer binary font to the graphic-LCD image font having a RGB value.

### BRIEF DESCRIPTION OF THE DRAWINGS

These and other features, aspects, and advantages of the present invention will become better understood with regard to the following description, appended claims, and accompanying drawings where:

FIG. 1 is a block diagram showing a conventional image forming apparatus having a graphic-liquid crystal display (graphic-LCD);

FIG. 2 is a block diagram of an image forming apparatus having a graphic-LCD according to an embodiment of the present invention;

FIG. 3 is a flowchart illustrating an operation of the image forming apparatus having the graphic-LCD according to an embodiment of the present invention; and

FIGS. 4A to 4C are drawings illustrating the operation of the image forming apparatus having the graphic-LCD according to an embodiment of the present invention.

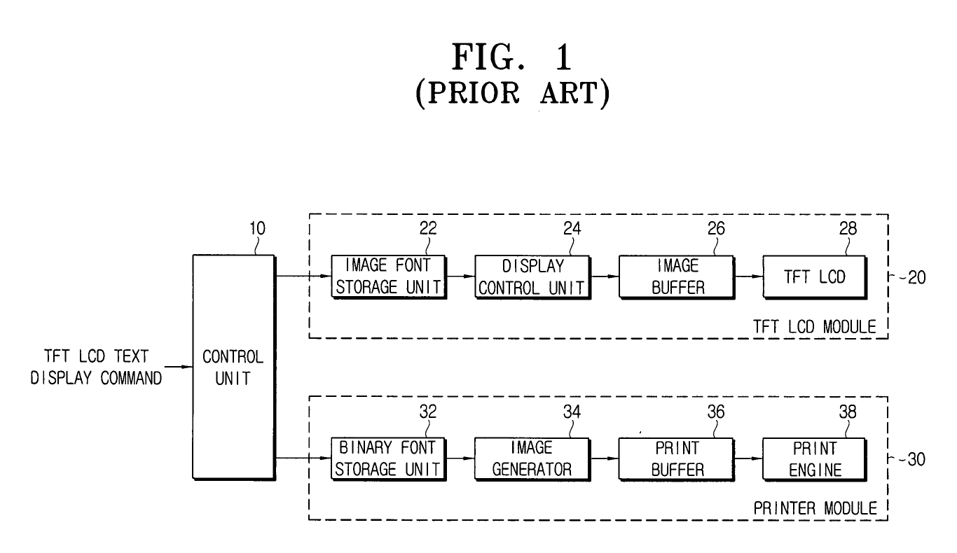

### DETAILED DESCRIPTION OF THE EXEMPLARY EMBODIMENTS

Hereinafter, embodiments of the present invention will be described in detail with reference to the accompanying drawings.

In the following description, the same drawing reference numerals are used for the same elements in different drawings. The matters defined in the description such as a detailed construction and elements are provided as examples to assist in understanding of the invention. Thus, it is apparent that the present invention can be carried out without those defined matters. Also, well-known functions or constructions are not described in detail since they would obscure the invention in unnecessary detail.

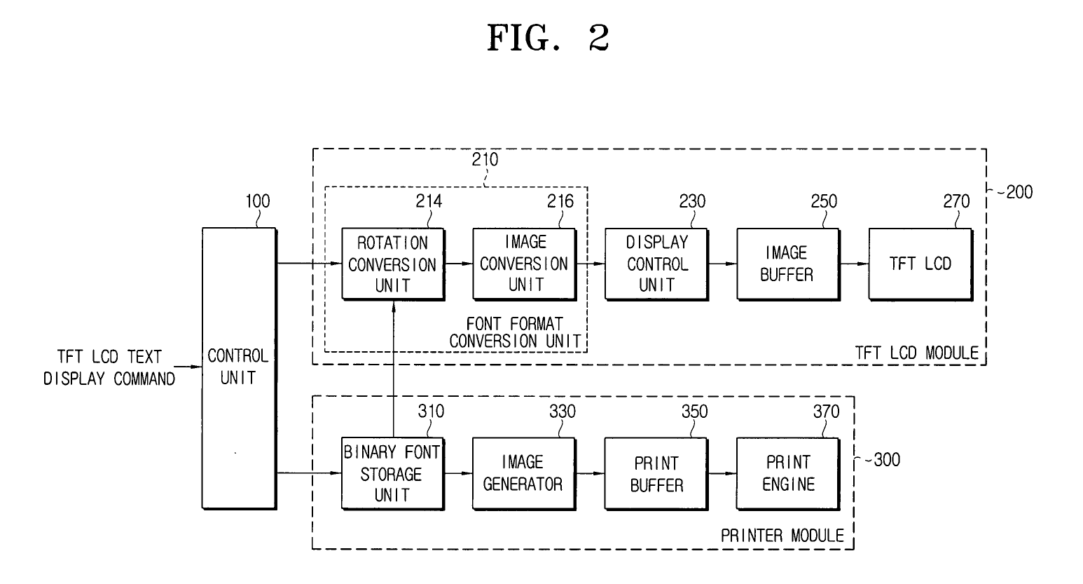

FIG. 2 is a block diagram of an image forming apparatus having a graphic-LCD according to an embodiment the present invention, which comprises a control unit 100, a graphic-LCD module 200, and a printer module 300.

The control unit 100 controls the printer module 300 for a print job, and controls the graphic-LCD 200 for displaying on the graphic-LCD data corresponding to an operating state and other information of the image forming apparatus. For the graphic-LCD, a thin film transistor liquid crystal display (TFT-LCD) is commonly used. In particular, when displaying text on the graphic-LCD, the control unit 100 transmits inkjet printer binary font data which is stored in the printer module 300 corresponding to the text to be displayed, to the graphic-LCD module 200 according to a predetermined graphic-LCD text display command.

The graphic-LCD module 200 displays image and text on the graphic-LCD. Particularly when displaying the text, the graphic-LCD module 200 converts the inkjet printer binary font to the graphic-LCD image font. The graphic-LCD module 200 comprises a font format conversion unit 210, a display control unit 230, an image buffer 250, and the graphic-LCD 270.

The font format conversion unit 210 comprises a rotation conversion unit 214, and an image conversion unit 216 to convert the received inkjet printer binary font to the graphic-LCD image font by the control unit 100.

Generally, the inkjet printer binary font is stored rotated clockwise by 270° C. due to the features of an inkjet printer which uses a nozzle. Accordingly, the rotation conversion unit 214 rotates the inkjet printer binary font counterclockwise to the correct position. Depending on the situation, a symmetrical conversion may be performed.

The image conversion unit 216 converts the binary font, in which an area to be printed is defined as “1”, and an area not to be printed is defined as “0”, to an image font having the RGB value. That is, “1”, which is the area to be printed, is converted to a RGB value (0, 0, 0) representing black, and “0”, which is the area not to be printed is converted to a RGB value (255, 255, 255) representing white. Thus, the binary font is converted to the graphic-LCD image font.

The display control unit 230 controls the RGB data of the converted graphic-LCD image font, adjusts color, and controls size. The image buffer 250 stores the graphic-LCD image font which is adjusted at the display control unit 230, and the graphic-LCD 270 displays the graphic-LCD image font stored in the image buffer 270.

The printer module 300 performs the printing. The printer module 300 comprises a binary font storage unit 310, an image generator 330, a print buffer 350, and a print engine 370.

The binary font storage unit 310 stores the inkjet printer binary data font rotated clockwise by 270° C. according to the features of the inkjet printer system. The inkjet printer binary data font defines an area to be printed as “1”, and an area to be not printed as “0”. The binary font is transmitted to the font format conversion unit 210 by the control unit 100 corresponding to the graphic-LCD text display command.

The image generator 330 receives from the binary font storage unit 310 the inkjet printer binary font for printing, and converts the received binary font to the image data. The print buffer 350 stores the image data processed at the image generator 350. The print engine 370 prints the image data of the print buffer 350.

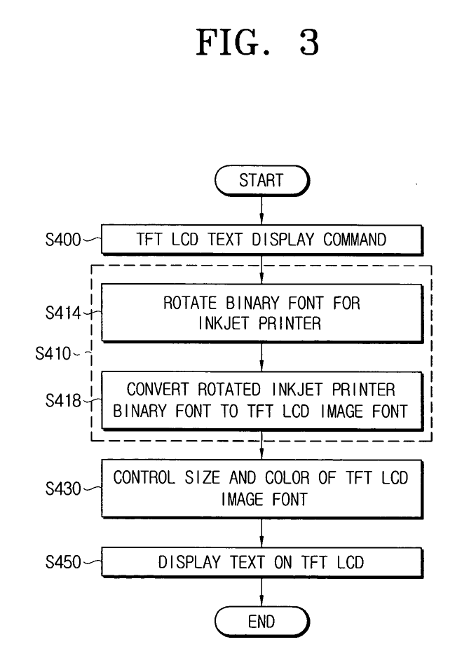

FIG. 3 is a flowchart illustrating the operation of the image forming apparatus having the graphic-LCD according to an embodiment of the present invention. Referring to FIGS. 2 and 3, the control unit 100 receives the graphic-LCD text display command from a predetermined inputting means at step S400, and transmits the font of the text to be printed, from the binary font storage unit 310 of the printer module 300 to the font format conversion unit 210, corresponding to the graphic-LCD text display command.

The font format conversion unit 210 converts the inkjet printer binary font data to the graphic-LCD image data font at step S410. More specifically, the font format conversion unit 210 rotates the inkjet printer binary font to the correct position for display at step S414, and converts the rotated binary font to the image font having the RGB values at step S418.

Next, the color and size of the converted graphic-LCD image font is controlled at step S430, and the graphic-LCD image font is displayed at step S450.

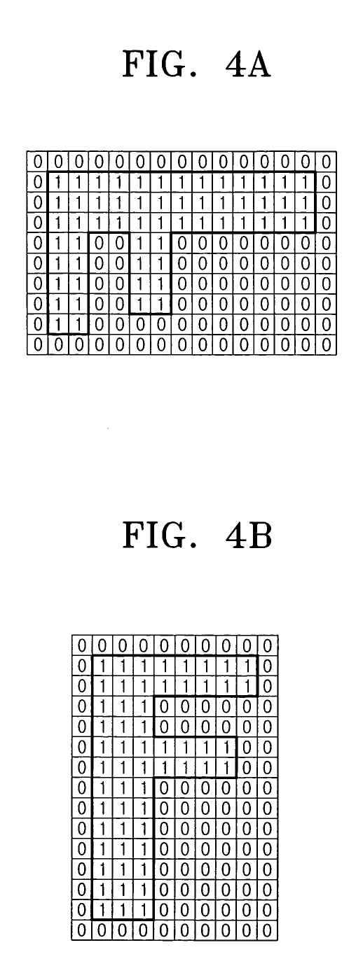

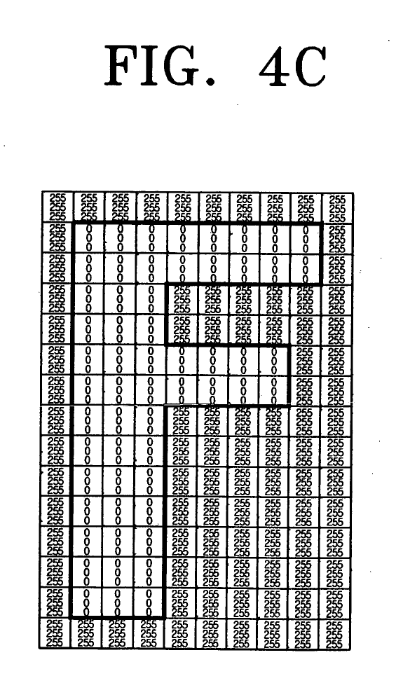

FIGS. 4A to 4C are drawings illustrating the operation of the image forming apparatus having the graphic-LCD according to an embodiment the present invention. FIG. 4A shows a data form of the inkjet printer binary font, FIG. 4B shows a data form of the rotated inkjet printer binary font, and FIG. 4C shows a data form of the graphic-LCD image font.

In FIG. 4A, the data form of the inkjet printer binary font is stored in the binary font storage unit 310. The font is rotated according to the printing system of the inkjet printer. In addition, “1” represents the area to be printed, and “0” represents the area not to be printed.

FIG. 4B shows the data form of the font which is processed by the rotation conversion unit 214 of the font format conversion unit 210. The rotation conversion unit 214 rotates or symmetrically moves the rotated inkjet printer binary font which is stored in the binary font storage unit 310 to the correct position for display.

FIG. 4C shows the data form of the graphic-LCD image font which is converted by the image conversion unit 216 of the font format conversion unit 210. The image conversion unit 216 converts the area to be printed to the RGB value (0, 0, 0) corresponding to black, and the area not to be printed to the RGB value (255, 255, 255) corresponding to white.

According to the above, the inkjet printer binary font is converted to the graphic-LCD image font, and therefore, a memory space for storing the graphic-LCD image font can be saved.

As described above, according to embodiments of the present invention, the image forming apparatus does not have to have an extra memory for storing the font for the graphic-LCD. Therefore, the manufacturing cost of the image forming apparatus is saved. Further, a variety of font forms that the image forming apparatus applies are also applicable to the graphic-LCD.

Although the present invention has been shown and described with reference to certain exemplary embodiments thereof, it should be understood by those skilled in the art that various changes in form and details may be made therein without departing from the spirit and scope of the invention as defined by the appended claims.

1. An image forming apparatus having a graphic-liquid crystal display (graphic-LCD), comprising:
a printer module for storing a binary font for use in an inkjet printer, and converting the inkjet printer binary font which corresponds to an input data to an image data for printing; and
a graphic-LCD module for displaying a state of the printer module on a screen, converting the inkjet printer binary font to the graphic-LCD image font, and displaying text on the screen.

2. The image forming apparatus of claim 1, wherein the printer module comprises:
a binary font storage for storing the inkjet printer binary font;
an image generator for converting the inkjet printer binary font to the image data; and
a print engine for printing the image data on paper.

3. The image forming apparatus of claim 1, wherein the graphic-LCD module comprises:
a font format conversion unit for converting the inkjet printer binary font to the graphic-LCD image font;
a display control unit for controlling color and size of the converted graphic-LCD image font; and
a graphic-LCD for displaying the controlled graphic-LCD image font.

4. The image forming apparatus of claim 3, wherein the font format conversion unit comprises:
a rotation conversion unit for rotating the inkjet printer binary font being displayed to a correct position; and
an image conversion unit for converting the inkjet printer binary font to the graphic-LCD image font having a Red Green Blue (RGB) value.

5. The image forming apparatus of claim 1, wherein the image forming apparatus comprises an office machine combined with at least one of a facsimile, a copier, a printer, and a scanner, and the graphic-LCD module displays a state of the office machine.

6. A method for a graphic-liquid crystal display (graphic-LCD) of an image forming apparatus which prints out text using a binary font for an inkjet printer, comprising the steps of:
reading the inkjet printer binary font; and
graphic-LCD processing for converting the read inkjet printer binary font to a graphic-LCD image font, and displaying the text based on the converted graphic-LCD image font.

7. The method of claim 6, wherein the graphic-LCD processing comprises the steps of:
font format converting for converting the read inkjet printer binary font to the graphic-LCD image font;
display controlling for controlling a color and size of the converted graphic-LCD image font; and
graphic-LCD displaying for displaying the controlled graphic-LCD image font on a screen.

8. The method of claim 7, wherein the font format converting comprises the steps of:
rotation converting for rotating the inkjet printer binary font being displayed to a correct position; and
image converting for converting the inkjet printer binary font to the graphic-LCD image font having a Red Green Blue (RGB) value.

9. The method of claim 6, further comprising the steps of:
image generating for converting the inkjet printer binary font to the image data; and
printing the image data on a paper.

10. The method of claim 6, wherein the image forming apparatus comprises an office machine combined with at least one of a facsimile, a copier, a printer, and a scanner, and the graphic-LCD module displays a state of the office machine.

11. A graphic-liquid crystal display (graphic-LCD) which displays text using a binary font for an inkjet printer, comprising:
a binary font storage unit for storing the inkjet printer binary font;
a font format conversion unit for converting the inkjet printer binary font to the graphic-LCD image font;
a display control unit for controlling a color and size of the converted graphic-LCD image font; and
a graphic-LCD for displaying the controlled graphic-LCD image font.

12. The graphic-LCD of claim 11, wherein the font format conversion unit comprises:
a rotation conversion unit for rotating the inkjet printer binary font being displayed to a correct position; and
an image conversion unit for converting the inkjet printer binary font to the graphic-LCD image font having a Red Green Blue (RGB) value.

13. A method for a graphic-liquid crystal display (graphic-LCD) which displays text using a font for an inkjet printer, comprising the steps of:
storing an inkjet printer binary font;
font format converting for converting the read inkjet printer binary font to the graphic-LCD image font;
display controlling for controlling a color and size of the converted graphic-LCD image font; and
graphic-LCD displaying for displaying the controlled graphic-LCD image font on a screen.

14. The method of claim 13, wherein the font format converting comprises the steps of:
rotation converting for rotating the inkjet printer binary font being displayed to a correct position; and
image converting for converting the inkjet printer binary font to the graphic-LCD image font having a Red Green Blue (RGB) value.
